(19) United States
(12) Patent Application Publication
(10) Pub. No.: US 2018/0285511 A1
(43) Pub. Date: Oct. 4, 2018

(54) INFORMATION PROCESSING APPARATUS, DESIGN SUPPORT METHOD, AND RECORDING MEDIUM STORING DESIGN SUPPORT PROGRAM

(71) Applicant: FUJITSU LIMITED, Kawasaki-shi (JP)

(72) Inventors: Koji DEMIZU, Atsugi (JP); Hidekatsu Sasaki, Kawasaki (JP); Hirooki Hayashi, Kawasaki (JP)

(73) Assignee: FUJITSU LIMITED, Kawasaki-shi (JP)

(21) Appl. No.: 15/865,314

(22) Filed: Jan. 9, 2018

(30) Foreign Application Priority Data
Apr. 3, 2017 (JP) 2017-073534

(51) Int. Cl. G06F 17/50; G06F 17/30

(52) U.S. Cl. CPC G06F 17/5081; G06F 17/30477

(57) ABSTRACT

An information processing apparatus, includes: a processor; and a memory configured to store a program executed by the processor, wherein the processor, based on the program: obtains first clearance information about a first clearance between a plurality of first components at an indicated point of a first product; associates the first clearance information with indicated point information about the indicated point; obtains second clearance information about a second clearance between a plurality of second components of a second product; searches for the first clearance information similar to the second clearance information; and outputs the indicated point information corresponding to the searched first clearance information.

### CROSS-REFERENCE TO RELATED APPLICATION

This application is based upon and claims the benefit of priority of the prior Japanese Patent Application No. 2017-073534, filed on Apr. 3, 2017, the entire contents of which are incorporated herein by reference.

### FIELD

The embodiments discussed herein are related to an information processing apparatus, a design support method, and a recording medium storing a design support program.

### BACKGROUND

In development of products such as various terminal devices, situations such as a previous defect point or an indicated point, are confirmed and verified by referring to information on a defect occurred in the past or a point indicated by a designer or the like in the past.

In order to manage a situation on a development progress or on a defect occurrence, indicated point information including an image of an indicated point, a cause of a defect, a countermeasure for the defect or the like is accumulated as a defect report, a checklist, or the like.

Related technologies are disclosed in, for example, Japanese Laid-Open Patent Publication No. 2015-026173, Japanese Laid-Open Patent Publication No. 2015-171736, or Japanese Laid-Open Patent Publication No. 2013-114484.

### SUMMARY

According to one aspect of the embodiments, an information processing apparatus, includes: a processor; and a memory configured to store a program executed by the processor, wherein the processor, based on the program: obtains first clearance information about a first clearance between a plurality of first components at an indicated point of a first product; associates the first clearance information with indicated point information about the indicated point; obtains second clearance information about a second clearance between a plurality of second components of a second product; searches for the first clearance information similar to the second clearance information; and outputs the indicated point information corresponding to the searched first clearance information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing apparatus;

FIG. 2 is a diagram illustrating an example of information stored in a storage unit illustrated in FIG. 1;

FIG. 3 is a diagram illustrating an example of a functional configuration of a processing unit illustrated in FIG. 1;

FIG. 4 is a diagram illustrating an example of a functional configuration of an output unit illustrated in FIG. 1;

FIG. 5 is a diagram illustrating an example of processing by the information processing apparatus;

FIG. 6 is a diagram illustrating an example of processing of registration of an indicated point and creating of indicated point information;

FIG. 7 is a diagram illustrating an example of creating processing of an adjacent group of a clearance;

FIG. 8 is a diagram illustrating an example of search processing of a similar point to the indicated point;

FIG. 9 is a diagram illustrating an example of stored contents of component information illustrated in FIG. 2;

FIG. 10A is a diagram illustrating an example of a three dimensional (3D) computer-aided design (CAD) image display when a defect occurs and the like;

FIG. 10B is a diagram illustrating an example of an indication image display as indicated point information extracted from the 3D CAD image illustrated in FIG. 10A;

FIG. 11 is a diagram illustrating an example of a classification which does not depend on an assembly structure of the CAD;

FIG. 12 is a diagram illustrating an example of a classification table obtained for the classification example illustrated in FIG. 11;

FIGS. 13A to 13C are diagrams illustrating an example of a facing surface pair;

FIG. 13D is a diagram illustrating an example of grouping processing of facing surface pairs;

FIG. 14 is a diagram illustrating an example of an adjacent group obtained by the grouping processing;

FIG. 15 is a diagram illustrating an example of an intersurface distance and a measurement point;

FIG. 16 is a diagram illustrating an example of a geometric center of the adjacent group;

FIGS. 17A to 17D are diagrams illustrating an example of an extracted cross section;

FIG. 18 is a diagram illustrating an example of a note table;

FIG. 19 is a diagram illustrating an example of a dimension table;

FIG. 20 is a diagram illustrating an example of a cross section table;

FIG. 21 is a diagram illustrating an example of an indicated point table;

FIG. 22 is a diagram illustrating an example of an indication table;

FIG. 23 is a diagram illustrating an example of a similarity table;

FIG. 24 is a diagram illustrating an example of a similar point determination table;

FIG. 25 is a diagram illustrating an example of a list display screen displaying an indicated point search result;

FIGS. 26A and 26B are diagrams illustrating an example of a similar point display screen;

FIG. 27 is a diagram illustrating an example of a disposition display in a 3D space of a new adjacent group;

FIG. 28 is a diagram illustrating an example of a similar point determination (point-of-attention estimation); and

FIG. 29 is a diagram illustrating an example of an operation of a point-of-attention reproducing unit.

### DESCRIPTION OF EMBODIMENTS

A defect point where a defect occurs or an indicated point which has been pointed out by a designer or the like may be referred to as an “indicated point”. For example, accumulated defect reports or checklists are utilized for developing a product. Determination as to indicated point information in the defect report or the checklist corresponds to which part in the currently developed product (new product) is conducted by a personal confirmation operation, such as visual recognition by a designer or the like.

Accordingly, in order for the designer or the like to specify and obtain indicated point information corresponding to a point of interest of the currently developed product from a large amount of accumulated indicated point information, it takes a lot of time, and, further, a problem may arise in view of a reliability of a specific result of the indicated point information.

For example, indicated point information about a previous product may be output in association with a similar point of a new product.

For example, the structure of previous indicated point is distinguished as the unit of a clearance, not as an assembly structure or a position relationship between components, so that in a new product, a product of which a design has progressed, or a version-up (minor change) product, a point having a design structure similar to the structure of the corresponding previous indicated point is extracted. Hereinafter, a point having a design structure similar to a structure of a corresponding previous indicated point may be referred to as a “similar point”. Further, a new product, a product of which a design has progressed, or a version-up (minor change) product may be referred to as a “second product” or a “new product and the like”.

Accordingly, it is not necessary to select a component corresponding to a point of interest where there is a possibility of occurrence of a defect in a new product or the like by a visual recognition of a designer or the like. Further, a similar point may be searched and extracted by using a shape of a portion (e.g., a cross-sectional shape), not an entire shape of the component, without relying on an assembly structure of a connection of the components. Accordingly, a designer or the like may automatically obtain all of the similar points in a new product or the like without selecting a component.

For example, a similar point in a new product or the like is estimated and extracted by combining a classification type and a clearance of the components around an indicated point.

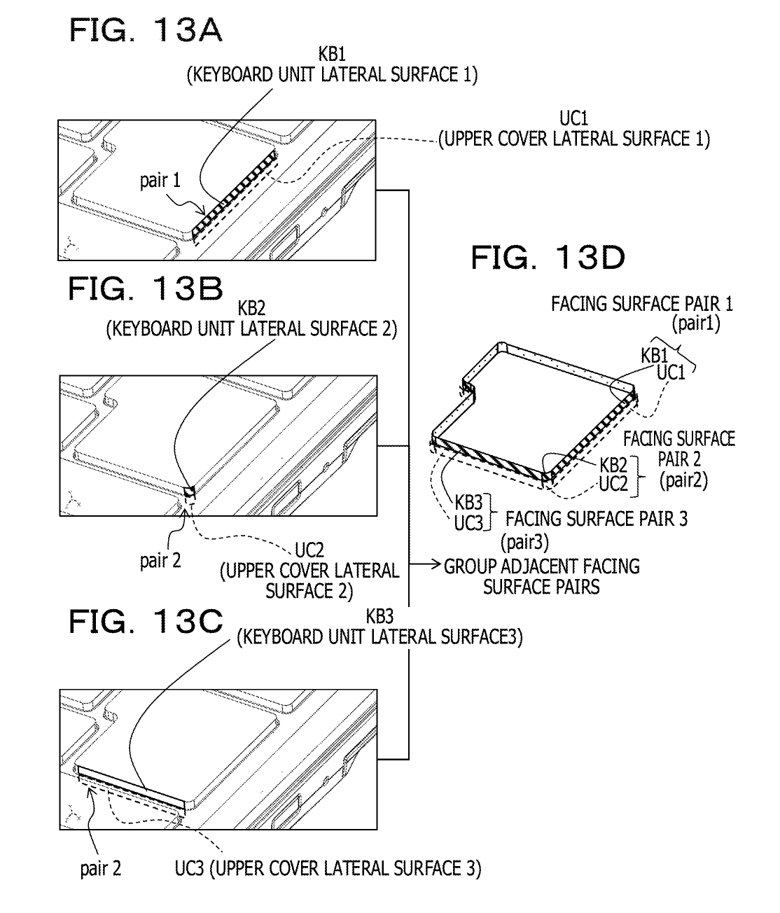

Herein, a clearance is formed between the components of the different classification types. The clearance is formed by a pair (hereinafter, referred to as a “facing surface pair”) of a surface of one component (one component surface) and a surface of the other component facing the surface of the one component (the other component surface). A corresponding surface is configured with a plurality of consecutive (adjacent) surface units (e.g., plane, cylindrical surface, curved surface, and the like) in an outer circumferential surface or an inner circumferential surface of each component (see, e.g., FIGS. 13A to 13D).

For example, as described above, a plurality of consecutive (adjacent) facing surface pairs which faces each other while forming a clearance is extracted as an inter-component clearance. In this case, a pair of one component surface and the other component surface of which a distance with the one component surface is minimum and is equal to or smaller than a predetermined value (e.g., 3 mm), among one or more other component surfaces facing the corresponding one component surface, is extracted as a facing surface pair.

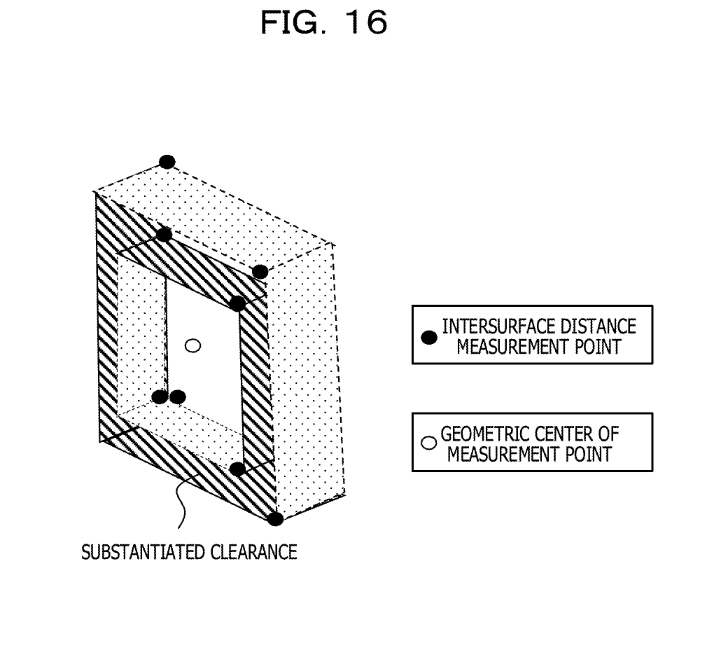

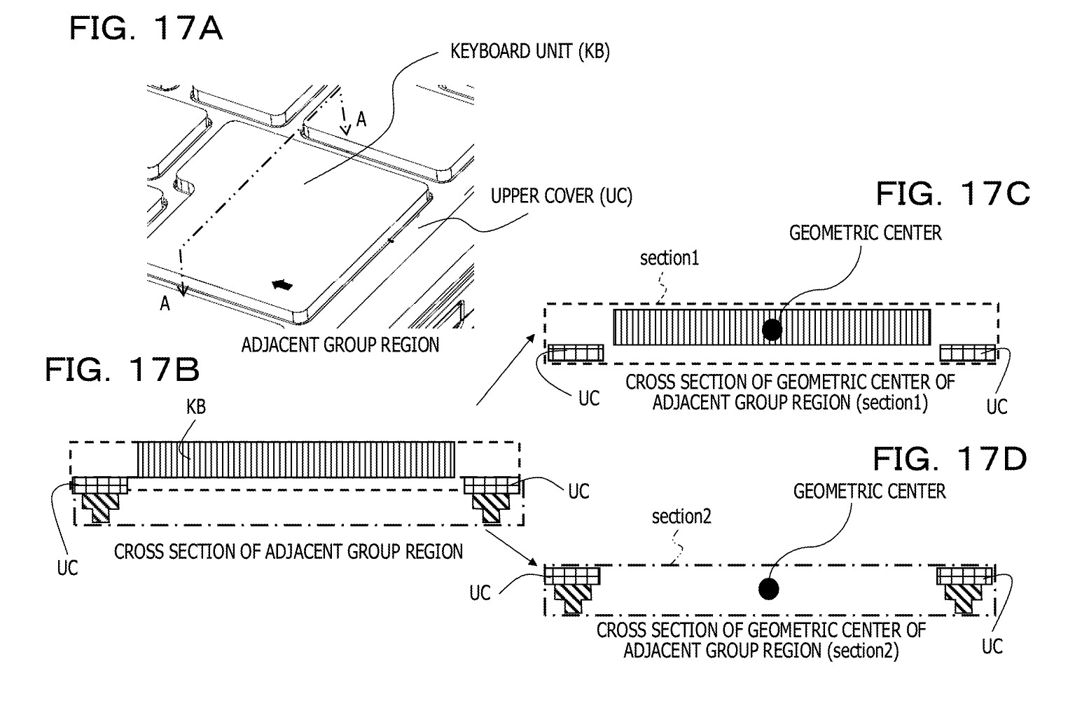

For example, the plurality of extracted adjacent facing surface pairs are grouped as an adjacent group of one set of clearances. Hereinafter, the adjacent group of the clearance may be simply referred to as an “adjacent group” or a “clearance group”. In this way, a similar point in a new product or the like is extracted by using a geometric center (see, e.g., FIG. 16 and FIGS. 17A to 17D) based on a measurement point used when the grouped facing surface pair (a clearance between the components) is extracted. In this case, the preciseness of the similar point may be secured by obtaining the plurality of adjacent groups for one indicated point and using a combination of the plurality of adjacent groups.

For example, a similar point is searched and estimated by confirming a partial match between the components. Accordingly, even when the plurality of points having the same shape (e.g., clearances between an upper cover and the plurality of keys of a keyboard unit) which do not depend on an entire shape of a component are objects to be searched of the similar point, each of the plurality of points may be identified as a similar point.

Further, the search for the similar point may be performed without relying on an entire shape of a component, and the range of a processing target may be narrowed by a combination of the classification type of the component which is to be described below and then the similar point may be identified. Accordingly, a search range of the similar point may be narrowed, and a time required for extracting a similar point may be decreased. In this case, a similarity determination is performed by using two or more adjacent groups when the indicated point is specified as described above, thereby reducing the occurrence of an erroneous match determination.

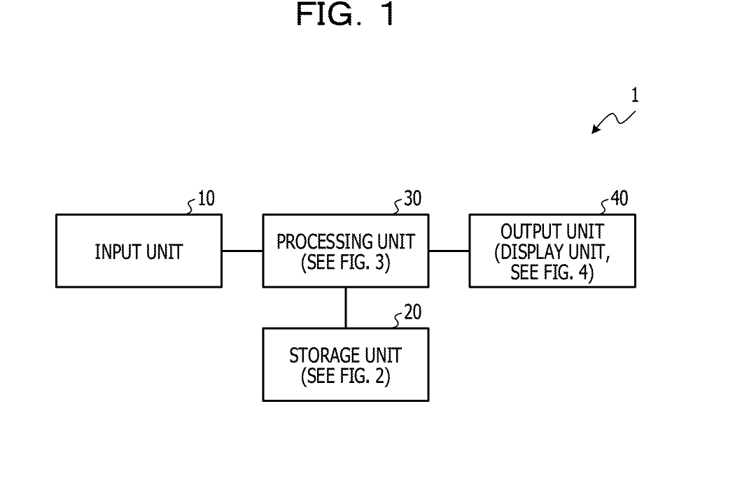

For example, even when a product is a new product or the like, a corresponding point of a defect case is readily searched as a similar point and defect information (indicated point information) is presented to a designer or the like. For example, information about an indicated point of a previous product (first product) may be output in association with a similar point of a new product or the like (second product). Accordingly, a recurrence of the defect may be certainly prevented, and a designer or the like does not need to perform a search of a checklist, a defect report, or the like. FIG. 1 illustrates an example of an information processing apparatus.

As illustrated in FIG. 1, an information processing apparatus 1 registers indicated point information, such as defect information, about a previous product (e.g., a first product), searches for a similar point similar to an indicated point of a currently designed new product or the like (e.g., a second product), and displays and outputs the indicated point information in association with the searched similar point. The information processing apparatus 1 is a computer such as, for example, a personal computer or a server computer, and includes an input unit 10, a storage unit 20, a processing unit 30, and an output unit 40. The input unit 10, the storage unit 20, the processing unit 30, and the output unit 40 are coupled so as to communicate with one another via a bus.

The input unit 10 is an input device for inputting various information. The input unit 10 may include an input device receiving an input of an operation of a mouse, a keyboard, a touch panel, an operation button, or the like. The input unit 10 receives various inputs. For example, the input unit 10 receives an operation input from a user, such as a designer, and inputs operation information indicating received operation contents into the processing unit 30.

The storage unit 20 stores a program, such as an operation system (OS), firmware, and an application, and various data. As for the storage unit 20, various storage devices, such as a magnetic disk device including a hard disk drive (HDD), a semiconductor drive device including a solid state drive (SSD), and a non-volatile memory, may be used. As for the non-volatile memory, for example, a flash memory, a storage class memory (SCM), a read only memory (ROM), or the like may be used. As for the storage unit 20, a volatile memory, for example, a RAM, such as a dynamic RAM (DRAM), may also be used. The RAM is an abbreviation of a random access memory. A program executing the entirety or a portion of various functions of a computer 1 may be stored in the storage unit 20.

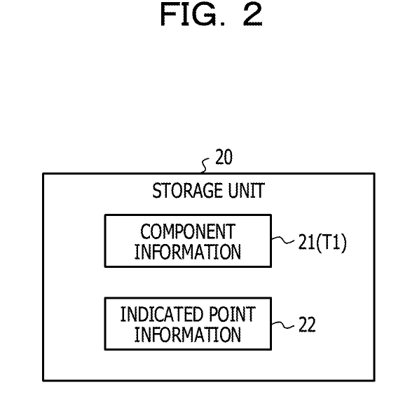

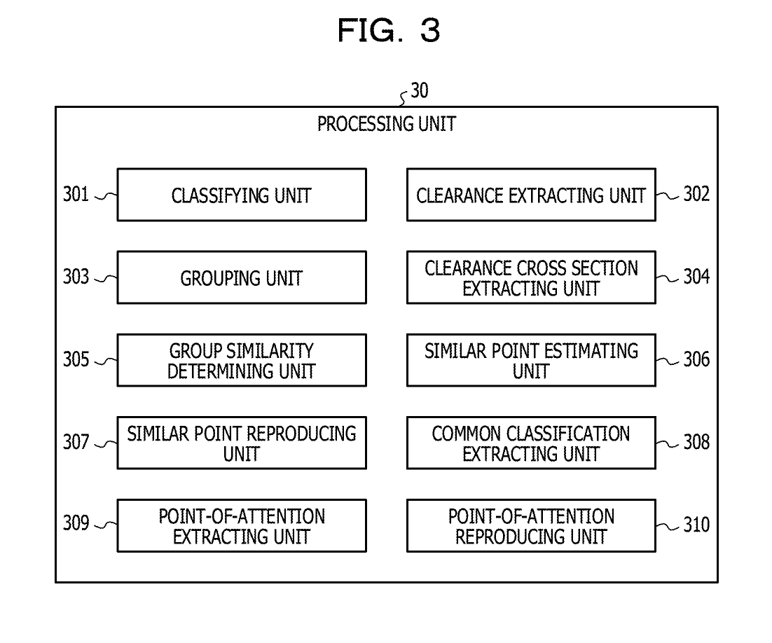

The storage unit 20 stores various information used by the information processing apparatus 1 to execute an indicated point registration, a search, and a display processing, in addition to a design support program executed by the processing unit 30 so as to implement various functions (see reference numerals 301 to 310) illustrated in FIG. 3. The corresponding various information may include component information 21 and indicated point information 22 illustrated in FIG. 2. FIG. 2 illustrates an example of information stored in the storage unit illustrated in FIG. 1.

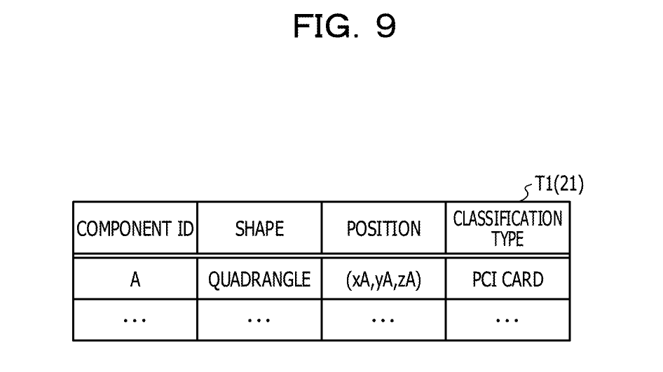

The component information 21 may be shape data (e.g., 3D CAD data) of a plurality of component models included in a three-dimensional (3D) assembly model about a previous product (e.g., a first product) or a new product or the like (e.g., a second product). The component information 21 is provided as, for example, information in the form of a table as represented in Table T1 with reference to FIG. 9. The component information 21 is input from, for example, the input unit 10, a communication interface, a medium reading unit, or the like, and is stored in the storage unit 20.

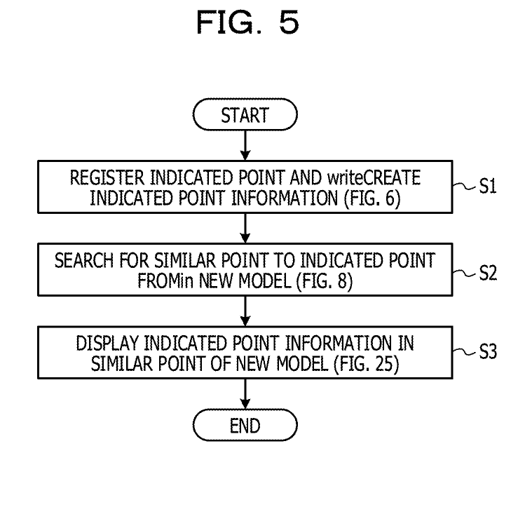

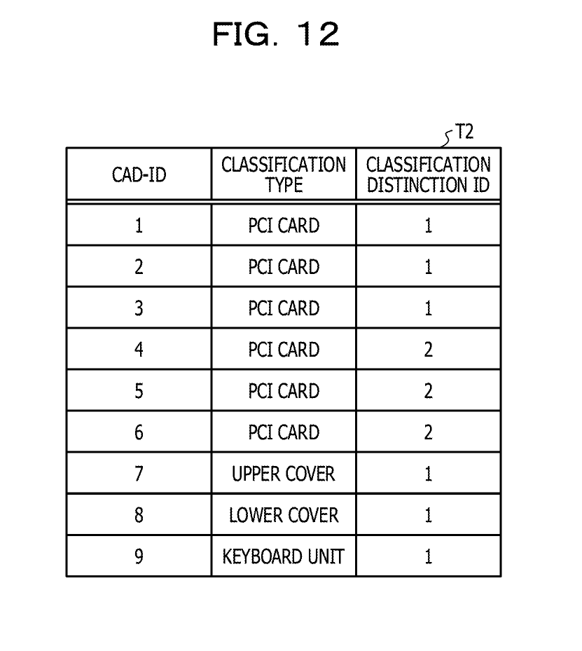

The indicated point information 22 is created by the processing unit 30 as illustrated in FIGS. 5 to 7 when a defect point (indicated point) is generated, and registered in the storage unit 20. In the storage unit 20, information in the form of a table, such as Tables T2 to T10 represented in FIGS. 12, 14, and 18 to 24, respectively, may be stored as corresponding various information.

The processing unit 30 performs various controls or calculations by using various information stored in the storage unit 20 by executing the program and the like stored in the storage unit 20. As for the processing unit 30, an integrated circuit (IC), such as a CPU, a GPU, an MPU, a DSP, an ASIC, and a PLD (e.g., an FPGA) may be used. CPU is an abbreviation of a central processing unit, GPU is an abbreviation of a graphics processing unit, and MPU is an abbreviation of a micro processing unit. DSP is an abbreviation of a digital signal processor, and ASIC is an abbreviation of an application specific integrated circuit. PLD is an abbreviation of a programmable logic device, FPGA is an abbreviation of a field programmable gate array, and IC is an abbreviation of an integrated circuit.

The processing unit 30 executes the design support program of the present exemplary embodiment stored in the storage unit 20 to serve as a classifying unit 301, a clearance extracting unit 302, a grouping unit 303, a clearance cross section extracting unit 304, a group similarity determining unit 305, a similar point estimating unit 306, a similar point reproducing unit 307, a common classification extracting unit 308, a point-of-attention extracting unit 309, and a point-of-attention reproducing unit 310 as illustrated in FIG. 3. FIG. 3 illustrates an example of a functional configuration of the processing unit illustrated in FIG. 1.

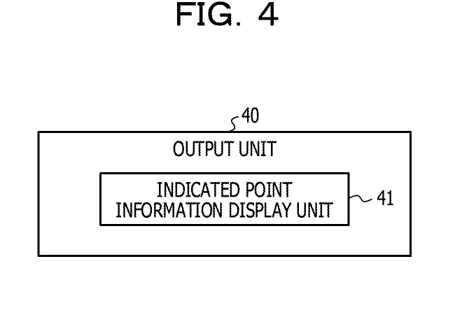

The output unit 40 includes a display unit of which a display state is controlled by various functions implemented by executing, by the processing unit 30, the design support program of the present exemplary embodiment. As for the output unit 40, various output devices, such as a liquid crystal display, an organic electroluminescence (EL) display, a plasma display, a projector, and a printer, may be used. The output unit (display unit) 40 serves as an indicated point information display unit 41 as illustrated in FIG. 4 by the various functions implemented by the processing unit 30. FIG. 4 illustrates an example of a functional configuration of the output unit illustrated in FIG. 1.

The information processing apparatus 1 may include a communication interface or a medium reading unit. The communication interface performs a connection with another device, a communication control, or the like via a network. The communication interface may include, for example, an adapter conforming to the Ethernet (registered trademark), optical communication (e.g., fibre channel), or the like or a network interface card, such as a local area network (LAN) card. A program and the like may be downloaded by using the communication interface via the network.

The medium reading unit is a reader which reads data or a program recorded in a recording medium and writes the read data or program in the storage unit 20 or inputs the read data or program into the processing unit 30. Examples of the medium reading unit may include an adapter conforming to the universal serial bus (USB), a drive device performing an access to a recording disk, a card reader performing an access to a flash memory, such as an SD card, and the like. A program and the like may be stored in the recording medium.

Examples of the recording medium may include a non-transitory computer readable recording medium, such as a magnetic/optical disk or a flash memory. Examples of the magnetic/optical disk may include a flexible disk, a compact disc (CD), a digital versatile disc (DVD), a blu-ray disc, a holographic versatile disc (HVD), and the like. Examples of the flash memory may include a semiconductor memory, such as a USB memory or an SD card. Further, examples of the CD may include a CD-ROM, CD-R, and CD-RW. Further, examples of the DVD may include a DVD-ROM, a DVD-RAM, a DVD-R, a DVD-RW, a DVD+R, a DVD+RW, and the like.

For example, the processing unit 30 and the output unit 40 may have the functions of the classifying unit 301, the clearance extracting unit 302, the grouping unit 303, the clearance cross section extracting unit 304, the group similarity determining unit 305, the similar point estimating unit 306, the similar point reproducing unit 307, the common classification extracting unit 308, the point-of-attention extracting unit 309, the point-of-attention reproducing unit 310, and the indicated point information display unit 41.

The classifying unit 301 classifies a component in a currently displayed indicated point into a classification distinction identification (ID) (see, e.g., FIG. 12) from a display of the indicated point when the indicated point is generated by a designer or the like with reference to a classification type (see, e.g., FIG. 9) of the component information 21 about the previous product. In the meantime, the classifying unit 30 classifies the entire components of a new product or the like into the classification distinction ID (see, e.g., FIG. 12) from a 3D assembly model of the new product or the like with reference to the classification type (see, e.g., FIG. 9) of the component information 21 about the new product or the like. A component forming a clearance is identified in the unit of a classification distinction ID classified by the classifying unit 301 as represented in a classification table T2 (see, e.g., FIG. 12).

The clearance extracting unit 302 extracts an adjacency relationship including relative adjacent directions of the components classified by the classifying unit 301.

In the indicated point, the clearance extracting unit 302 extracts a pair of one first component surface and the other first component surface, in which a first distance between the one first component surface and the other first component surface is minimum and the first distance is equal to or smaller than a first predetermined value (e.g., 3 mm), among one or more of other first component surfaces facing the first component surface as a first facing surface pair (see, e.g., FIGS. 13A to 13C). The one first component surface corresponds to one surface (a plane, a cylindrical surface, a curved surface, and the like) of the classified one component in the indicated point. The other first component surface corresponds to one surface (a plane, a cylindrical surface, a curved surface, and the like) of the classified other component in the indicated point. The one first component surface and the other first component surface correspond to the first facing surface pair in the minimum unit which forms a clearance between the first components in the indicated point.

In the new product or the like, the clearance extracting unit 302 extracts a pair of one second component surface and the other second component surface, in which a second distance between the one second component surface and the other second component surface is the minimum and the second distance is equal to or smaller than a second predetermined value (e.g., 3 mm), among one or more of other second component surfaces facing the one second component surface, as a second facing surface pair (see, e.g., FIGS. 13A to 13C). The one second component surface corresponds to one surface (a plane, a cylindrical surface, a curved surface, and the like) of the classified one component in the new product or the like. The other second component surface corresponds to one surface (a plane, a cylindrical surface, a curved surface, and the like) of the classified other component in the new product or the like. The one second component surface and the other second component surface correspond to the second facing surface pair in the minimum unit which forms a clearance between the second components in the new product or the like.

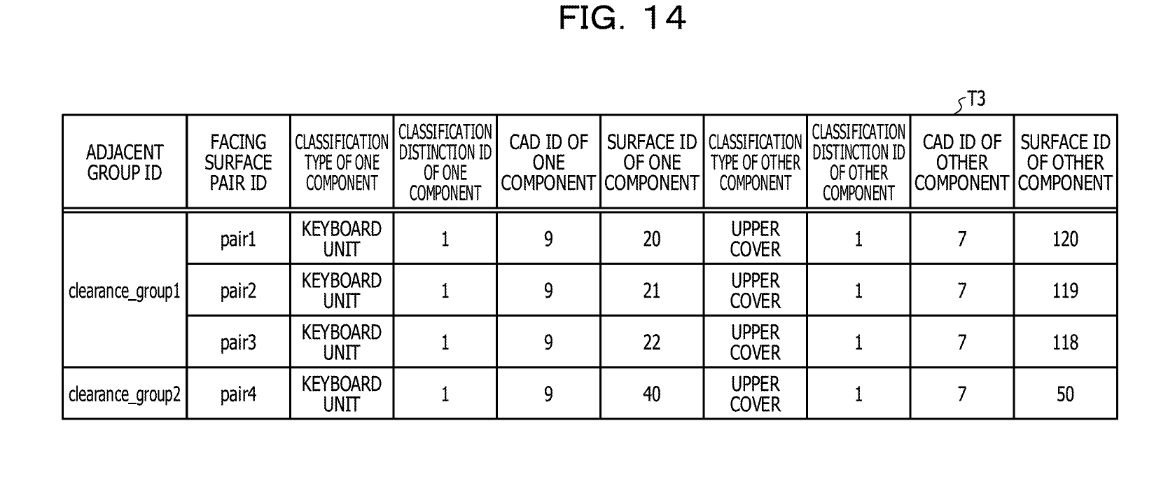

The grouping unit 303 groups consecutive (adjacent) first facing surface pairs or second facing surface pairs extracted for the one component and the other component of the same combination among the first facing surface pairs or the second facing surface pairs extracted by the clearance extracting unit 302 into the same adjacent group (see, e.g., FIGS. 13D and 14).

The clearance cross section extracting unit 304 extracts a cross section representing the first facing surface pair or the second facing surface pair (clearance) belonging to the adjacent group for every adjacent group grouped by the grouping unit 303 (see, e.g., FIG. 16 and FIGS. 17A to 17D).

The clearance cross section extracting unit 304 obtains a cross section including a first geometric center based on a measurement point determined when the clearance (the adjacent first facing surface pair) between the first components according to the indicated point is extracted as a first cross section according to the indicated point. In this case, as for the first cross section, three cross sections, which include the first geometric center and are orthogonal to three axes defining XYZ spaces, respectively, may be obtained, and one of the three cross sections may be obtained.

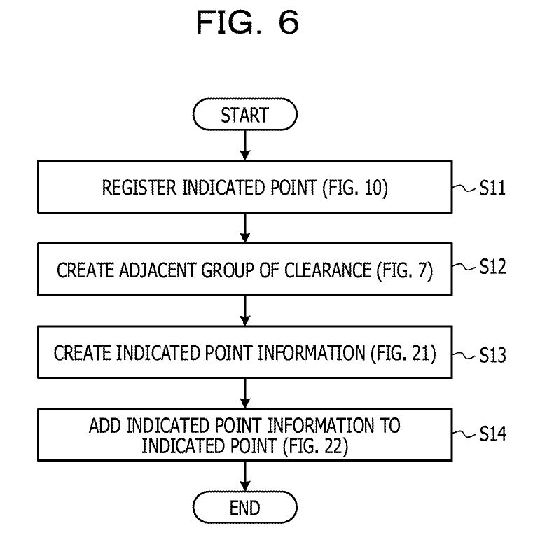

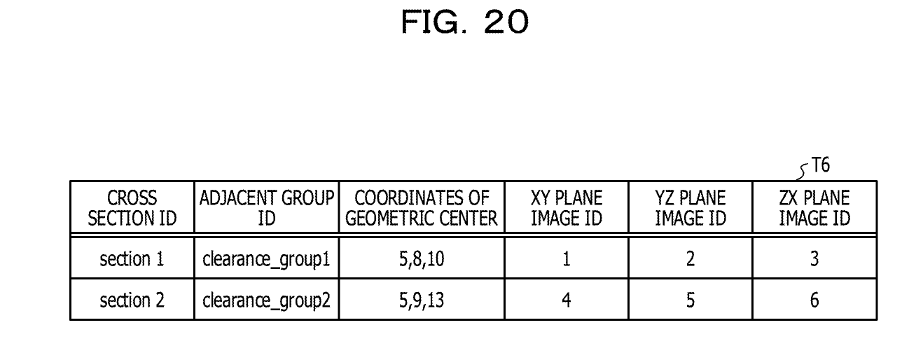

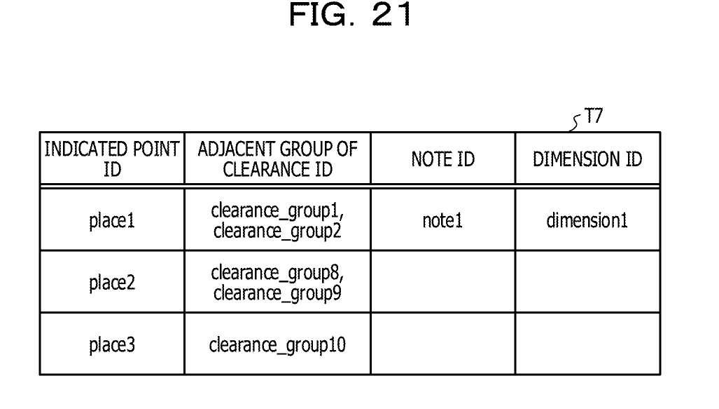

The first cross section obtained by the clearance cross section extracting unit 304 is included in first clearance information about the clearance between the first components in the indicated point together with a first classification type of the first component forming the clearance between the first components obtained by the classifying unit 301. The processing unit 30 manages the first clearance information and the indicated point information about the indicated point in association with each other (see, e.g., FIGS. 20 to 22). The indicated point information is created by the processing unit 30 (see, e.g., S1 of FIG. 5, and FIG. 6) and is made to correspond to an indicated point ID specifying the indicated point to include an image of the indicated point, a reason of the defect, a countermeasure of the defect, and the like. The image of the indicated point is specified by an indication image ID, the reason of the defect or the countermeasure of the defect is text information (indication sentence) and is specified by an indication sentence ID (see, e.g., FIG. 21).

The clearance cross section extracting unit 304 obtains a cross section including a second geometric center based on a measurement point determined when the clearance (e.g., the adjacent second facing surface pair) between the second components according to the new product or the like is extracted as a second cross section according to the new product or the like. In this case, as the second cross section, three cross sections, which include the second geometric center and are orthogonal to three axes defining XYZ spaces, respectively, may be obtained, and one of the three cross sections may be obtained.

The second cross section obtained by the clearance cross section extracting unit 304 is included in second clearance information about the clearance between the second components in the new product or the like together with a second classification type of the second component forming the clearance between the second components obtained by the classifying unit 301.

The processing unit 30 searches for the first clearance information similar to the second clearance information obtained for the new product or the like and outputs the indicated point information corresponding to the searched first clearance information by the functions as the group similarity determining unit 305, the similar point estimating unit 306, the similar point reproducing unit 307, and the indicated point information display unit 41 which are to be described below.

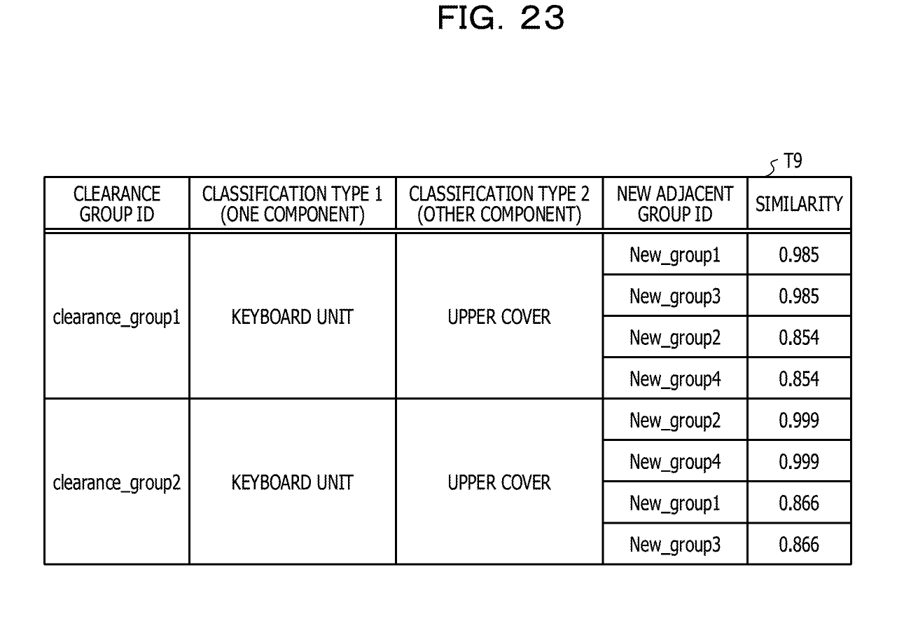

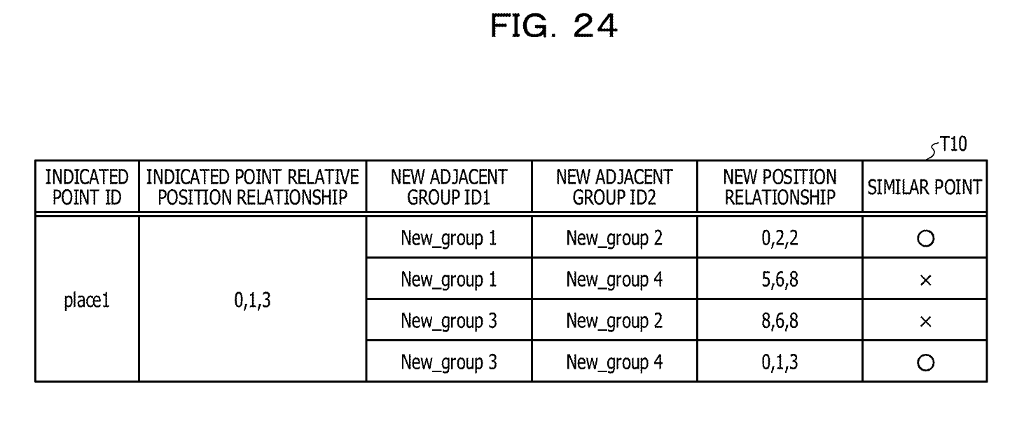

For example, when the second classification type in the second clearance information matches the first classification type in the first clearance information, the processing unit 30 calculates similarity between the second cross section and the first cross section, and searches for the first clearance information similar to the second clearance information according to the calculated similarity (see, e.g., FIG. 23). The processing unit 30 extracts a similar point of the new product or the like which is similar to the indicated point based on a relative position relationship of the first geometric center for the two or more first components and a relative position relationship of the second geometric center for the two or more second components (see, e.g., FIG. 24).

When the second classification type in the second clearance information obtained for the new product or the like matches the first classification type in the registered first clearance information, the group similarity determining unit 305 calculates similarity between the second cross section in the second clearance information and the first cross section in the first clearance information in which the classification type matches (see, e.g., FIGS. 14 and 23). As described above, a range of the processing target is narrowed by the combination of the classification types of the component, and then the similar point is identified.

The similar point estimating unit 306 estimates and extracts a similar point of the new product or the like similar to the indicated point based on the relative position relationship of the first geometric center about two or more first components (e.g., the first adjacent group) and the relative position relationship of the second geometric center about two or more second components (e.g., the second adjacent group) (see, e.g., FIG. 24).

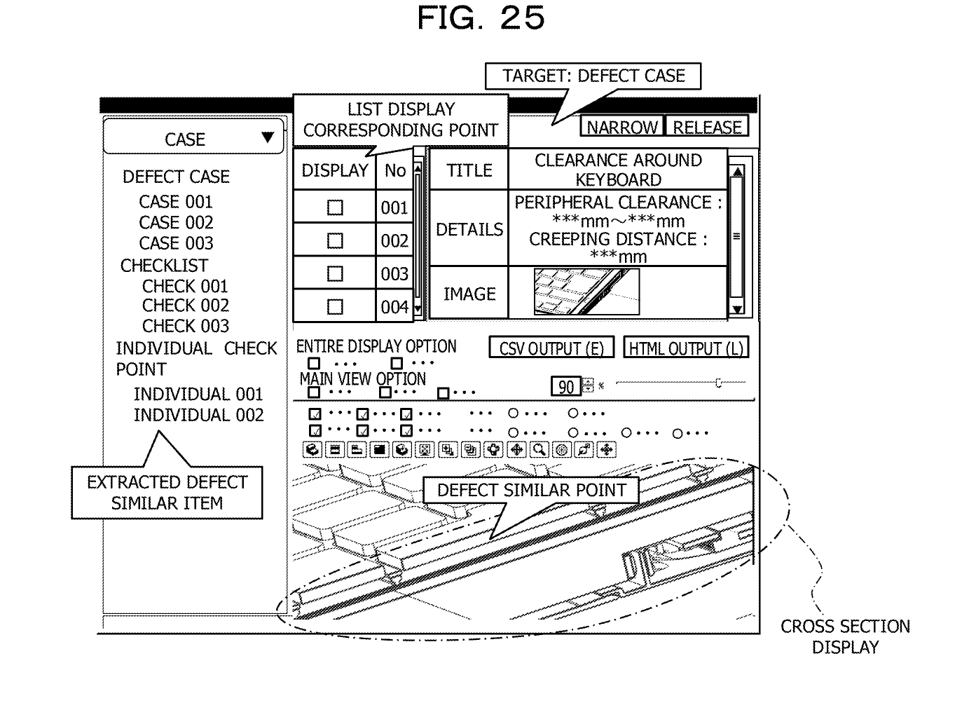

The similar point reproducing unit 307 controls a display state of the output unit 40 so that the output unit 40 displays the similar point extracted by the similar point estimating unit 306 for the new product or the like. In this case, the similar point information corresponding to the similar point such as, for example, the image of the indicated point and text of the reason of the defect, the countermeasure of the defect, or the like, is displayed in a display region of the similar point or a neighboring region (the indicated point information display unit 41) of the display region of the output unit 40 (see, e.g., FIG. 25).

The common classification extracting unit 308 extracts a combination having high commonality from the similar point estimated in the new product or the like (other type of product). For example, the common classification extracting unit 308 accumulates a true/false determination on the similar point by the designer or the like, and adds the result of the accumulated true/false determinations to the similar point extracting processing by a statistical processing to improve the preciseness of the extraction of the similar point.

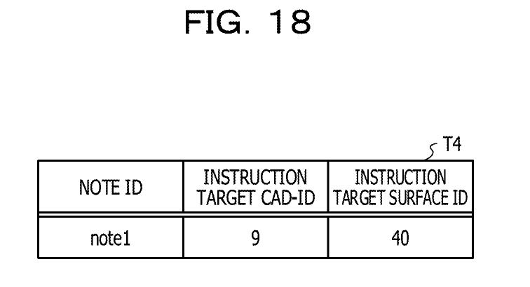

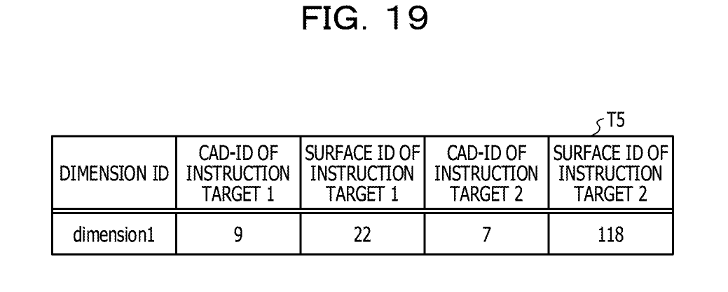

For example, when a note or a dimension is written for the indicated point, the point-of-attention extracting unit 309 extracts an instruction point (see, e.g., FIG. 18) of the note for the indicated point or an instruction point (see, e.g., FIG. 19) of the dimension for the indicated point as the point-of-attention. In this case, the processing unit 30 manages the extracted point-of-attention in association with the first clearance information and the indicated point information as described above.

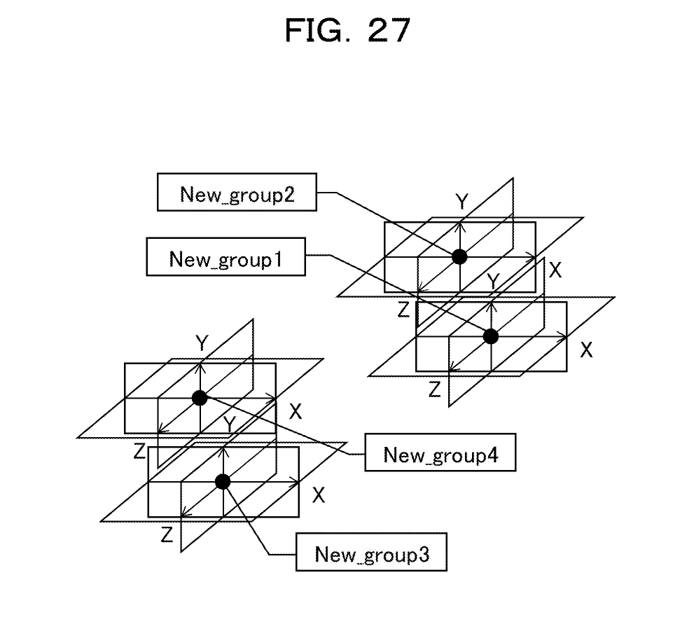

When two or more (in this case, two) similar points similar to one indicated point are extracted and estimated and the output unit 40 displays both two similar points entirely, the point-of-attention reproducing unit 310 changes a viewpoint position and performs the reproduction and the display in the unit similar to the indicated point. For example, the point-of-attention reproducing unit 310 changes a viewpoint position from a viewpoint position at which the entirety of both two similar points is included in a screen (fits the screen) to a viewpoint position at which only any one similar point (point-of-attention) fits the screen to perform the reproduction and the display in which only the point-of-attention fits the screen (see, e.g., FIGS. 27 to 29).

When operation S1 is initiated by the information processing apparatus 1, shape data (e.g., 3D CAD data) of each component configuring a product (e.g., a previous product, the first product) that is a processing target is stored in the storage unit 20 as the component information 21. Similarly, when operation S2 is initiated by the information processing apparatus 1, shape data (e.g., 3D CAD data) of each component configuring a new product (e.g., a new model, the second product) that is a processing target is stored in the storage unit 20 as the component information 21.

In this case, the component information 21 is given as the information in the form of a table like Table T1 represented in FIG. 9. An example of stored contents of the component information represented in FIG. 2 is given. In FIG. 9, a shape of a corresponding component (e.g., a quadrangle), a position of a corresponding component (e.g., (xA, yA, zA)), a classification type of a corresponding component (e.g., a PCI card), and the like are stored in association with a component ID (CAD-ID, e.g., “A”) specifying each component as the component information 21 (Table T1). PCI is an abbreviation of peripheral component interconnect.

The information processing apparatus 1 (processing unit 30) extracts and creates a clearance between the components (the clearance between the first components), clearance information (the first clearance information) about the clearance between the corresponding components, or indicated point information about the corresponding indicated point from the point (the indicated point, the defect point) in which a defect is pointed out by using the component information 21 about the previous product (operation S1 of FIG. 1). The corresponding clearance information includes a classification type (the first classification type) of the component (the first component) configuring the clearance between the corresponding components or a cross section (the first cross section) according to the clearance between the corresponding components. In operation S1, the processing unit 30 registers and stores the extracted corresponding clearance information and the corresponding indicated point information in the storage unit 20 in association with each other.

The processing unit 30 searches for a similar point similar to the indicated point registered in operation S1 from the new product or the like (e.g., the new model) (operation S2 of FIG. 5). In this case, the processing unit 30 extracts and creates the clearance between the components (a clearance between the second components) and the clearance information (the second clearance information) about the clearance between the corresponding components from the entirety of the new product or the like by using the component information 21 about the new product or the like. The clearance information includes a classification type (the second classification type) of the component (the second component) configuring the clearance between the corresponding components or a cross section (e.g., the second cross section) according to the clearance between the components. In operation S2, the processing unit 30 compares the first clearance information (the first classification type and the first cross section) with the second clearance information (the second classification type and the second cross section) to search for the similar point similar to the indicated point.

The processing unit 30 displays and outputs indicated point information about the indicated point similar to the similar point in the similar point searched in operation S2 on the display screen of the output unit 40 (operation S3 of FIG. 5). Accordingly, all of the similar points similar to the indicated point of the previous product are extracted from the new product or the like, and the indicated point information corresponding to the extracted similar point is displayed for the designer or the like in association with the similar point. Accordingly, the designer or the like may easily and certainly recognize where the indicated point information of the previous product corresponds in the new product without performing a personal confirmation operation, such as visual recognition. Accordingly, the designer or the like does not need to specify the indicated point information corresponding to the point-of-attention of the new product or the like (the currently developed product) from the accumulated lots of indicated point information with lots of time, and further, reliability of a result of the specification of the indicated point information may be considerably improved. This will be described below.

Each component of the previous product including the indicated point is classified by the designer or the like, or machine learning or the like in advance, and a classification type of each component is set in advance (see, e.g., Table T1 of FIG. 9). Each component may be classified for each assembly unit while including an assembly state by the plurality of components, as well as for each single component. In the classification, a maximum exterior shape, a material name, density, volume, a model color, and an attribute of each component may be utilized.

After the classification type of each component is set in advance, the processing unit 30 registers the indicated point (operation S11 of FIG. 6).

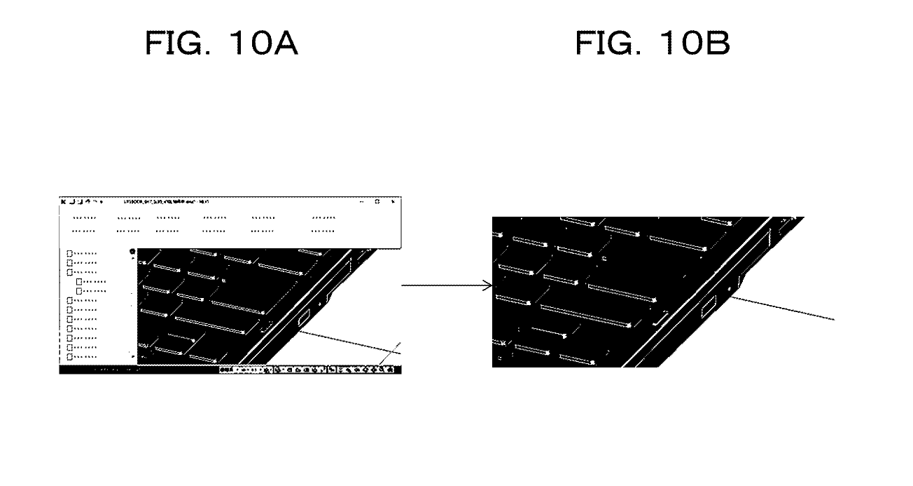

In operation S11, when the indicated point occurs in a model that is being designed, an image of the indicated point is extracted from the 3D CAD image as illustrated in FIG. 10A so that the designer or the like leaves the indicated point on record. The extracted image of the indicated point is enlarged so as to fit the screen of the output unit 40 as illustrated in FIG. 10B, and then the enlarged image is stored in the storage unit 20 as an indication image of the indicated point information 22, so that the indicated point occurring in this time is registered in the information processing apparatus 1. In this case, the indicated point ID specifying the indicated point is set and registered in an indicated point table T7 as illustrated in FIG. 21.

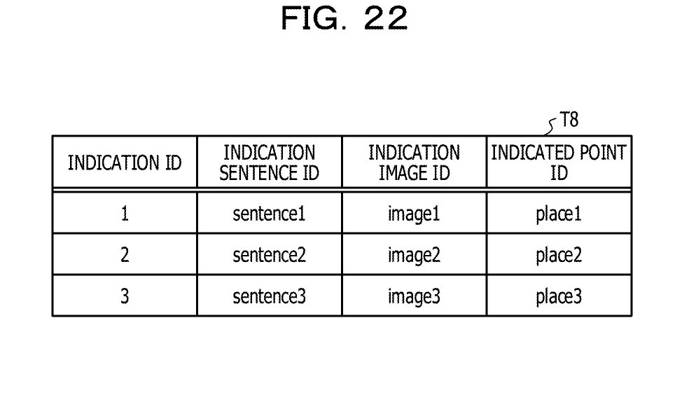

When there is a note (e.g., the reason or the countermeasure of the defect) or a dimension for the indicated point, the note or the dimension may be obtained in the form of an image from the corresponding indication image. The note may be obtained as text information, and may be stored in the storage unit 20 as an indication sentence of the indicated point information 22. In this case, as described above, the image of the indicated point is specified by the indication image ID, and the reason of the defect or the countermeasure of the defect is text information and is specified by the indication sentence ID (see, e.g., an indication table T8 of FIG. 22).

FIG. 10A illustrates an example of a 3D CAD image display when, for example, a defect occurs. FIG. 10B illustrates an example of an indication image display as indicated point information extracted from the 3D CAD image illustrated in FIG. 10A.

As described above, accompanying the registration processing of the indicated point, the processing unit 30 reads the shape data of the 3D assembly model (the component information 21) and creates an adjacent group of the clearance between the components (operation S12 of FIG. 6).

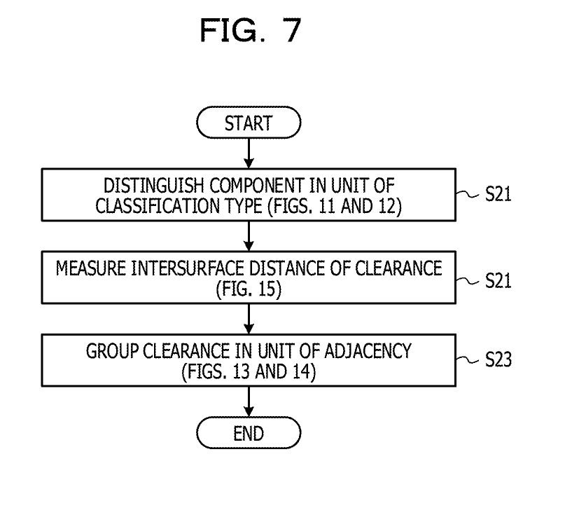

The processing unit 30 (classifying unit 301) classifies each component in the unit of the classification type (operation S21 of FIG. 7).

In operation S21, by the classifying unit 301, the component in the indicated point that is being displayed is classified into the classification distinction ID based on the classification type (Table T1 of FIG. 9) of the component information 21 about the previous product as in the classification table T2 illustrated in FIG. 12. The component in the indicated point is distinguished in the unit of the classification distinction ID such as, for example, in the unit of an assembly including one or more components, and the clearance between the components is extracted. Accordingly, the component is classified without relying on the assembly structure of the CAD.

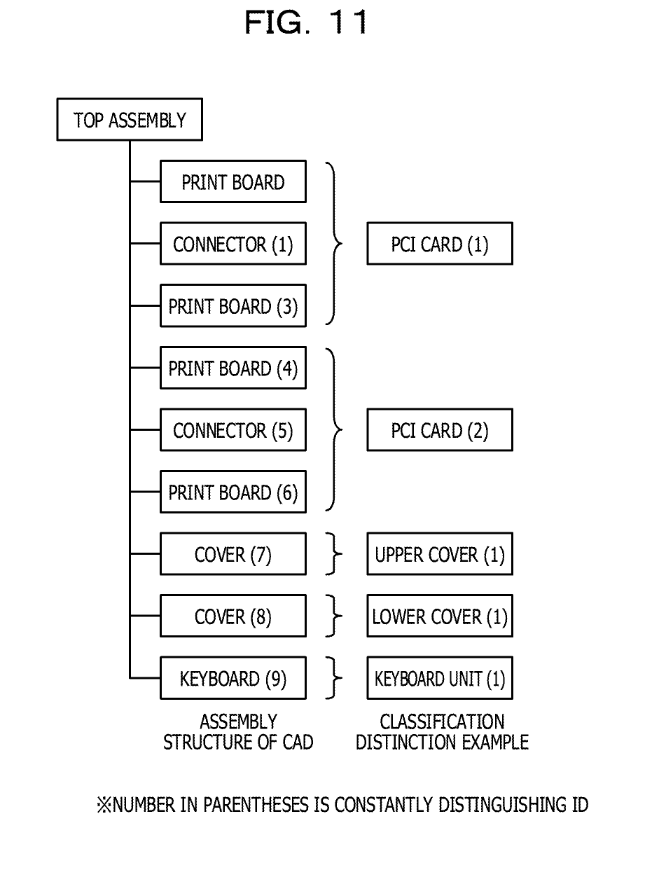

FIG. 11 illustrates an example of a classification which does not rely on an assembly structure of the CAD. FIG. 12 illustrates an example of a classification table obtained for the classification example illustrated in FIG. 11.

In an assembly structure of the CAD indicated at the left side of FIG. 11, nine components assigned with CAD-IDs (component ID) 1 to 9, respectively, belong to a top assembly. Hereinafter, a component assigned with a component IDi (i=1 to 9) is written as component (i). Each of the components (1) to (9) is set with a classification type in the component information 21 (Table T1). In FIGS. 11 and 12, a “PCI card” is set to components (1) to (6) as the classification type, and an “upper cover”, a “lower cover”, and a “keyboard unit” are set to components (7) to (9), respectively, as the classification types.

By the classifying unit 301, the assembly structure of the CAD indicated at the left side of FIG. 11 is abstracted as represented as a classification distinction example at the right side of FIG. 11, and each component configuring the assembly structure is classified into a classification distinction ID as represented in the classification table T2 of FIG. 12.

In the classification distinction example represented at the right side of FIG. 11 and the classification table T2 of FIG. 12, components (1) to (3) (a print board 1, a connector 2, and a print board 3) configure one PCI card, so that components (1) to (3), which are an assembly configuring the first sheet of PCI card, are classified into classification distinction ID1 for the PCI card and are distinguished as a PCI card (1).

Similarly, components (4) to (6) (a print board 4, a connector 5, and a print board 6) configure one PCI card, so that components (4) to (6), which are an assembly configuring the second sheet of PCI card, are classified into classification distinction ID2 for the PCI card and are distinguished as a PCI card (2).

As described above, each component is classified in the unit of the classification distinction ID, so that the component is classified without relying on the assembly structure of the CAD.

Then, the processing unit 30 (clearance extracting unit 302) measures the distances between all of the components classified (distinguished) by the classifying unit 301 such as, for example, the intersurface distances (adjacent distances) of all of the clearances (operation S22 of FIG. 7). In this case, in FIGS. 11 and 12, two PCI cards are present, but the different classification distinction IDs 1 and 2 are set to the two PCI cards, respectively, so that the two PCI cards 1 and 2 are distinguished and an intersurface distance with the other component is measured. The space between the components which have an intersurface distance that is within a range of, for example, 0 to 3 mm is acknowledged as the clearance between the components.

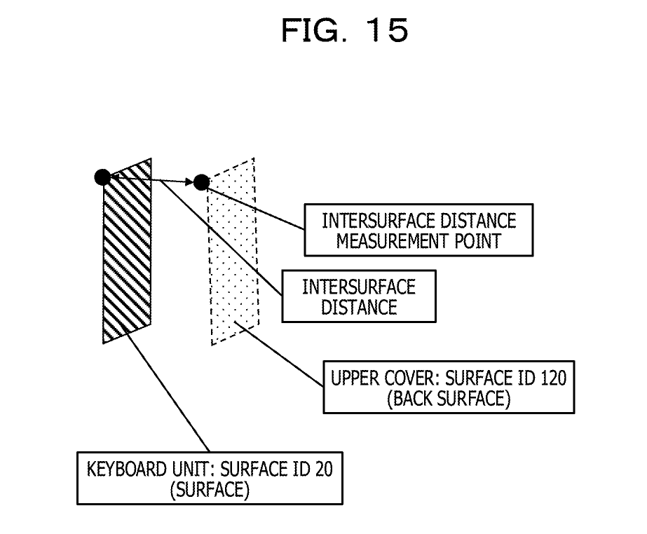

FIG. 15 illustrates an example of an intersurface distance and a measurement point. FIG. 15 illustrates an example of a measurement of an intersurface distance between a plane (surface) of surface ID 20 in the component of which the classification type is the keyboard unit and a surface (rear surface) of surface ID 120 in the component of which the classification type is the upper cover. Herein, as the intersurface distance, a minimum distance between two facing surfaces is measured. For example, a distance between measurement points (two facing peaks) on two planes illustrated in FIG. 15 is measured as an intersurface distance (adjacent distance). As described above, the measurement point for measuring the adjacent distance (adjacent distance measurement point) may be a start point and an end point of each plane.

In operation S22 of FIG. 7, in the indicated point, a pair of one component surface and the other component surface of which a distance with the one component surface is minimum and is equal to or smaller than a predetermined value (e.g., 3 mm), among one or more other component surfaces facing the one component surface, is extracted by the clearance extracting unit 302 as a facing surface pair based on a result of the measurement of the intersurface distance.

FIGS. 13A to 13C illustrate an example of a facing surface pair. In FIGS. 13A to 13C, the component of which the classification type is the keyboard is one component, and the component of which the classification type is the upper cover is the other component. An outer peripheral surface of a button of the keyboard is one component surface, and an inner peripheral surface of a button hole of the upper cover which the one button fits is the other component surface.

In this case, the outer peripheral surface of the button includes at least a plane KB1 (see, e.g., FIG. 13A), a curved surface KB2 (see, e.g., FIG. 13B) adjacent (consecutive) to the corresponding plane KB1, and a plane KB3 (see, e.g., FIG. 13C) adjacent (consecutive) to the corresponding curved surface KB2. The inner peripheral surface of the button hole includes at least a plane UC1 (see, e.g., FIG. 13A), a curved surface UC2 (see, e.g., FIG. 13B) adjacent (consecutive) to the plane UC1, and a plane UC3 (see, e.g., FIG. 13C) adjacent (consecutive) to the curved surface UC2. The plane KB1 of the keyboard and the plane UC1 of the upper cover make a facing surface pair 1 (pair1), the plane KB2 of the keyboard and the plane UC2 of the upper cover make a facing surface pair 2 (pair2), and the plane KB3 of the keyboard and the plane UC3 of the upper cover make a facing surface pair 3 (pair3).

Accordingly, in FIGS. 13A to 13C, by the clearance extracting unit 302, three facing surface pairs 1 to 3 are extracted based on the result of the measurement of the intersurface distance.

FIG. 13D illustrates an example of grouping processing of the facing surface pairs. The processing unit 30 (grouping unit 303) groups the clearances (facing surface pairs) extracted by the clearance extracting unit 302 in the unit of adjacency and creates an adjacent group of the clearances as illustrated in FIG. 13D (operation S23 of FIG. 7).

In operation S23, the consecutive (adjacent) facing surface pair extracted for one component and the other component of the same combination among the facing surface pairs extracted by the clearance extracting unit 302 is grouped into the same adjacent group by the grouping unit 303.

In FIG. 13D, as illustrated in FIGS. 13A to 13C, the three extracted facing surface pairs 1 to 3 are grouped into the same adjacent group. FIG. 13D is a diagram illustrating grouping processing for the facing surface pairs illustrated in FIGS. 13A to 13C.

When the grouping processing illustrated in FIGS. 13A to 13D is performed, an adjacent group table T3 illustrated in FIG. 14 is created by the processing unit 30 (grouping processing unit 303). FIG. 14 illustrates an example of an adjacent group obtained by the grouping processing.

In the adjacent group table T3 illustrated in FIG. 14, an ID of the adjacent group to which the three facing surface pairs 1 to 3 grouped as illustrated in FIG. 13D belong is “clearance_group1”. An ID of an adjacent group to which one facing surface pair 4 (not illustrated) belongs is “clearance_group2”. Hereinafter, the adjacent group having the adjacent group ID “clearance_group1” is referred to as an adjacent group clearance_group1. The adjacent group having the adjacent group ID “clearance_group2” is referred to as an adjacent group clearance_group2.

In the adjacent group table T3 illustrated in FIG. 14, according to the grouping result, the facing surface pair IDs “pair1” to “pair3” specifying the three facing surface pairs 1 to 3, respectively, correspond to the adjacent group clearance_group1. In the adjacent group table T3 illustrated in FIG. 14, information specifying one component surface and the other component surface forming each facing surface pair corresponds to each facing surface pair.

In FIG. 14, one component surface forming the facing surface pair 1 (pair1) is a surface specified with a surface ID 20 in a component of which the classification type is the keyboard unit, of which the classification distinction ID is 1, and of which the CAD-ID is 9. The other component surface forming the facing surface pair 1 is a surface specified with a surface ID 120 in a component of which the classification type is the upper cover, of which the classification distinction ID is 1, and of which the CAD-ID is 7.

Similarly, in FIG. 14, one component surface forming the facing surface pair 2 (pair2) is a surface specified with a surface ID 21 in a component of which the classification type is the keyboard unit, of which the classification distinction ID is 1, and of which the CAD-ID is 9. Further, the other component surface forming the facing surface pair 2 is a surface specified with a surface ID 119 in a component of which the classification type is the upper cover, of which the classification distinction ID is 1, and of which the CAD-ID is 7.

In FIG. 14, one component surface forming the facing surface pair 3 (pair3) is a surface specified with a surface ID 22 in a component of which the classification type is the keyboard unit, of which the classification distinction ID is 1, and of which the CAD-ID is 9. The other component surface forming the facing surface pair 3 is a surface specified with a surface ID 118 in a component of which the classification type is the upper cover, of which the classification distinction ID is 1, and of which the CAD-ID is 7.

In FIG. 14, one component surface forming the facing surface pair 4 (pair4) belonging to the adjacent group clearance_group2 is a surface specified with a surface ID 40 in a component of which the classification type is the keyboard unit, of which the classification distinction ID is 1, and of which the CAD-ID is 9. The other component surface forming the facing surface pair 4 is a surface specified with a surface ID 50 in a component of which the classification type is the upper cover, of which the classification distinction ID is 1, and of which the CAD-ID is 7.

The processing unit 30 creates the indicated point information (Tables T4 to T7 illustrated in FIGS. 18 to 21) (operation S13 of FIG. 6). In this case, the processing unit 30 extracts an adjacent group capable of being displayed (capable of being visualized) in the indicated point. During the extraction, the processing unit 30 selects an adjacent group in which a geometric center (see, e.g., FIG. 16) of an adjacent distance measurement point (intersurface distance measurement point, see, e.g., FIG. 15) exists within the display region. FIG. 16 illustrates an example of a geometric center of the adjacent group. In FIG. 16, rather than a physically existing component forming a clearance, a clearance (space) is substantiated and displayed.

In the case where there exists a note or a dimension to be added to the indication of the component when the component forming the clearance (facing surface pair) is indicated in the indicated point, the processing unit 30 selects an adjacent group including the component.

When the note is present, for example, a note table T4 illustrated in FIG. 18 is created and stored by the processing unit 30 (point-of-attention extracting unit 309). FIG. 18 illustrates an example of a note table. In the note table T4 illustrated in FIG. 18, a note ID (note1) specifying a corresponding note, an instruction target CAD-ID 9 specifying an instruction target component of the note, and an instruction target surface ID 40 specifying an instruction target surface in the instruction target component of the note correspond to one another.

When the dimension is present, for example, a dimension table T5 illustrated in FIG. 19 is created and stored by the processing unit 30 (point-of-attention extracting unit 309). FIG. 19 illustrates an example of a dimension table. In the dimension table T5 illustrated in FIG. 19, a dimension ID (dimension1) specifying a corresponding dimension, and IDs specifying both ends (instruction target 1 and instruction target 2) of the dimension correspond to one another. As for an ID specifying the instruction target 1, the CAD-ID 9 of the instruction target 1 that specifies a component of the instruction target 1 and the surface ID 22 that specifies an instruction target surface in the component of the instruction target 1 are included. As for an ID specifying the instruction target 2, the CAD-ID 7 of the instruction target 2 that specifies a component of the instruction target 2 and the surface ID 118 that specifies an instruction target surface in the component of the instruction target 2 are included.

As described above, for the adjacent group which is narrowed by the selection, the processing unit 30 (clearance cross section extracting unit 304) obtains a cross section including the geometric center (e.g., the first geometric center) illustrated in FIG. 16 as a first cross section according to the indicated point, and creates an image of the corresponding cross section fitted to a screen size of the output unit 40. In this case, as for the cross section, for example, three cross sections, which include the geometric center and are orthogonal to three axes defining XYZ spaces, respectively, are obtained.

FIGS. 17A to 17D illustrate an example of an extracted cross-section. FIG. 20 illustrates an example of a cross section table.

It is assumed that the adjacent group region illustrated in FIG. 17A configured with a keyboard unit (hereinafter, referred to as the “KB”) and an upper cover (hereinafter, referred to as the “UC”) is selected. In this case, as illustrated in FIG. 17B, each of the KB and the UC is divided into two portions including a portion having a facing adjacent surface (facing surface) (see the broken line frame of FIG. 17B) and a portion having no facing adjacent surface (see the alternated long and short dash line frame of FIG. 17B), and a cross section of each portion is extracted, and a cross section image for the cross section is created. FIG. 17B illustrates a cross section, for example, taken along line A-A of FIG. 17A.

For an upper region surrounded by the broken line frame of FIG. 17B, a geometric center is obtained. As illustrated in FIG. 17C, a cross section (a cross section ID is “section1”) including the geometric center is extracted, and a cross section image for the cross section is created. For a lower region surrounded by the alternated long and short dash line frame of FIG. 17B, the geometric center is obtained. As illustrated in FIG. 17D, a cross section (a cross section ID is “section2”) including the geometric center is extracted, and a cross section image for the cross section is created.

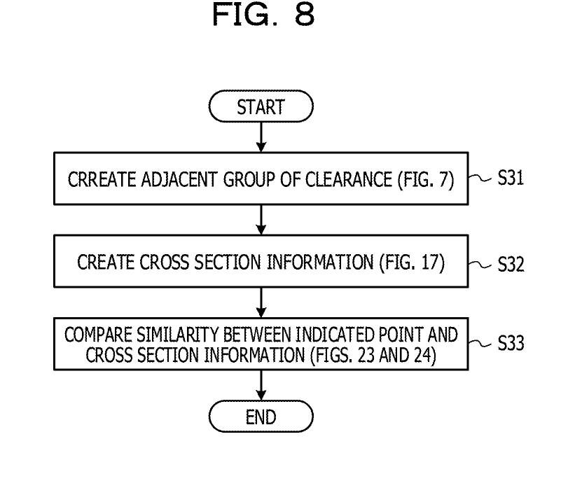

In this case, as for the cross section image, three plane images including an XY plane image that is orthogonal to the Z-axis, a YZ plane image that is orthogonal to the X-axis, and a ZX plane image that is orthogonal to the Y-axis may be created. The clearance cross section extracting unit 304 manages the extracted cross section image by using the cross section table T6 illustrated in FIG. 20. The cross section image (cross section information) managed by using the cross section table T6 is used for calculating similarity which is to be described below with reference to FIG. 8 (operation S33).

In the cross section table T6 illustrated in FIG. 20, a cross section ID that specifies a cross section, a clearance group ID that specifies a clearance group corresponding to a corresponding cross section, coordinates of a geometric center of a clearance group, an XY plane image ID that specifies an XY plane image, a YZ plane image ID that specifies a YZ plane image, and a ZX plane image ID that specifies a ZX plane image are associated with each other. For example, the cross section ID “section1” is associated with the clearance group ID “clearance_group1”, the geometric center coordinates (5, 8, 10), the XY plane image ID “1”, the YZ plane image “2”, and the ZX plane image “3”. Similarly, the cross section ID “section2” is associated with the clearance group ID “clearance_group2”, the geometric center coordinates (5, 9, 13), the XY plane image ID “4”, the YZ plane image “5”, and the ZX plane image “6”.

The processing unit 30 creates an indicated point table T7 illustrated in FIG. 21 and manages the indicated point. FIG. 21 is a diagram illustrating an example of an indicated point table. In the indicated point table T7 illustrated in FIG. 21, an indicated point ID that specifies an indicated point is associated with an adjacent group ID extracted and created for the indicated point, and the indicated point table 7 is linked with the cross section table T6 by the adjacent group ID. When there is a note or a dimension for the indicated point, in the indicated point table T7, the indicated point ID is associated with a note ID (e.g., note1) or a dimension ID (e.g., dimension1), and the indicated point table T7 is linked with the note table T4 or the dimension table T5 by the note ID or the dimension ID.

The processing unit 30 creates the indication table T8 illustrated in FIG. 22, and manages an indication by the designer and the like. FIG. 22 illustrates an example of an indication table. In the indication table T8 illustrated in FIG. 22, an indication ID is associated with an indication sentence ID, an indication image ID, and an indicated point ID. The indication ID specifies an indication by the designer or the like, and when the designer or the like makes an indication (a defect is generated) during the design or the like, the indication ID is set to the indication table T8 illustrated in FIG. 22. The indication sentence ID specifies text information of a reason of the defect or a countermeasure of the defect according to the corresponding indication. The indication image ID specifies an image of the indicated point extracted and created according to the corresponding indication. The indicated point ID specifies an indicated point that is a target of the corresponding indication, and the indication table T8 is linked with the indicated point table T7 by the indicated point ID.

As described above, in the indication table T8, the indication ID is associated with the indicated point ID, so that the first clearance information or the indicated point information 22 is added to an indicated point that is a target of each indication via Tables T2 to T7 (operation S14 of FIG. 6). For example, the indication sentence or the indication image input by the designer or the like for the indicated point and the indicated point automatically extracted and created by the information processing apparatus 1 of the present exemplary embodiment are associated with each other to be managed.

Accordingly, the processing unit 30 completes registration processing of the indicated point (defect point) by the processing of operation S1 of FIG. 5.

In the information processing apparatus 1, a similar point similar to a previously registered indicated point (defect point) is searched for the target product of the new product or the like (the new model or the like) as described below.

During the search for the similar point, classification setting of every component, distinction in the unit of the classification type of every component, a measurement of a clearance between all of the components, and grouping of the clearances (facing surface pairs) between the all of the components are performed based on a 3D assembly model of the new product or the like.

For all of the components of a target product, the same classification set as item [3-2-1] is performed. For all of the components of the target product, the same distinction in the unit of the classification type as item [3-2-3-1], the same measurement of a clearance between the components as item [3-2-3-2], and the same grouping of the clearances (facing surface pairs) between the components (creating a new adjacent group of the clearances) as item [3-2-3-3] are performed (operation S31 of FIG. 8). The foregoing processing may be executed by a back-end system (e.g., the information processing apparatus 1).

Then, for each of all of the new adjacent groups obtained for the target product, the processing unit 30 (clearance cross section extracting unit 304) obtains a cross section including the geometric center (the second geometric center) illustrated in FIG. 16 as a second cross section for each new adjacent group, and creates an image of a cross section fitted to the screen size of the output unit 40 (operation S32 of FIG. 8). In this case, the obtainment processing of the cross section is performed in the same order as the order above described in item [3-2-4]. In the absence of the note or the dimension, the same cross section information as that of the first cross section for the indicated point is created as information about the second cross section. The creation processing of the cross section information like this may be executed by a back end system (e.g., the information processing apparatus 1).

When the classification type (e.g., the second classification type) obtained for the new product or the like matches the classification type (e.g., the first classification type) for the registered indicated point, the processing unit 30 (group similarity determining unit 305) calculates similarity between the cross section (e.g., the second cross section) for the new product or the like and the cross section (e.g., the first cross section) of the registered indicated point (operation S33 of FIG. 8). As described above, a range of the processing target is narrowed by the combination of the classification types of the component, and then the similar point is identified. The similarity between the first cross section and the second cross section is calculated, for example, by machine learning (image determination) or statistical processing based on a feature amount of the two cross section images.

The processing unit 30 (e.g., the similar point estimating unit 306) estimates and extracts a similar point of the new product or the like similar to the indicated point based on a relative position relationship of the first geometric centers for two or more first components and a relative position relationship of the second geometric centers for two or more second components (operation S33 of FIG. 8). Herein, the two or more first components (e.g., the first adjacent group) correspond to, for example, two adjacent groups clearance_group1 and clearance_group2. The two or more second components (e.g., the second adjacent group) correspond to two or more new adjacent groups newly extracted and created from the new product or the like as described above.

In this case, the similar point estimating unit 306 may estimate the point corresponding to the new adjacent group having the highest similarity or the new adjacent group having similarity that has a predetermined value or more based on the similarity calculated for each new adjacent group as the similar point of the indicated point.

FIG. 23 illustrates an example of a similarity table.

FIG. 24 illustrates an example of a similar point determination table.

Herein, the case where four new adjacent groups in which the combination of the classification types is the “keyboard unit” and the “upper cover” for the new product or the like are extracted and created will be described. Hereinafter, the case where four new adjacent groups are created will be described. A new adjacent group having a new adjacent group ID “New_groupi” (i=1 to 4) is referred to as a new adjacent group New_groupi.

In this case, as illustrated in FIG. 23, a classification type (e.g., the second classification type) obtained for each of the new adjacent groups New_group1 to New_group4 matches the classification types (e.g., the first classification type) “keyboard unit” and “upper cover” (see the adjacent group table T3 of FIG. 14) of the component configuring the adjacent groups clearance_group1 and clearance_group2 for the registered indicated point.

In this case, the group similarity determining unit 305 calculates similarity between each of the cross sections section1 and section2 (see, e.g., the cross section table T6 of FIG. 20) obtained for the adjacent groups clearance_group1 and clearance_group2 and the cross section obtained in operation S32 for each of the new adjacent groups New_group1 to New_group4. As a result, for example, in the similarity table T9 illustrated in FIG. 23, similarity between the adjacent group clearance_group1 and each of the new adjacent groups New_group1 to New_group4 was obtained as 0.985, 0.854, 0.985, and 0.854. Identically, similarity between the adjacent group clearance_group2 and each of the new adjacent groups New_group1 to New_group4 was obtained as 0.866, 0.999, 0.866, and 0.999. The cross sections section1 and section 2 are cross sections specified by the cross section IDs “section1” and “section2”, respectively.

In this case, the similar point estimating unit 306 extracts the indicated point of which the indicated point ID is “place1” as a determination target of the similar point based on the combination of the adjacent group IDs “clearance_group1” and “clearance_group2” along with the indicated point table T7 illustrated in FIG. 21. The similar point estimating unit 306 obtains a relative position relationship between the indicated points described below based on the indicated point ID “place1” and the cross section table T6 illustrated in FIG. 20. For example, for the two adjacent groups clearance_group1 and clearance_group2 configuring the indicated point place1, a relative position relationship (0, 1, 3) corresponding to a difference between coordinates (5, 8, 10) of the geometric center of the adjacent group clearance_group1 and coordinates (5, 9, 13) of the geometric center of the adjacent group clearance_group2 is obtained (see, e.g., the similar point determination table T10 of FIG. 24).

The similar point estimating unit 306 selects two new adjacent groups, New_group1 and New_group3, having high similarity as candidate groups corresponding to the adjacent group clearance_group1 by referring to the similarity table T9 illustrated in FIG. 23. Similarly, the similar point estimating unit 306 selects two new adjacent groups New_group2 and New_group4 having high similarity as candidate groups corresponding to the adjacent group clearance_group2 by referring to the similarity table T9 illustrated in FIG. 23.

In this case, the number of combinations of the two new adjacent groups (ID1 and ID2) corresponding to the indicated point place1 is four sets including New_group1 and New_group2, New_group1 and New_group4, New_group3 and New_group2, and New_group3 and New_group4 as illustrated in FIG. 24.

The similar point estimating unit 306 obtains coordinates of a relative position of each of the combinations of the two new adjacent groups. For example, a relative position relationship corresponding to a difference between coordinates of the geometric center of the new adjacent groups specified with ID1 and coordinates of the geometric center of the new adjacent groups specified with ID2 is obtained. For example, in the similar point determination table T10 illustrated in FIG. 24, relative position relationships (0, 2, 2), (5, 6, 8), (8, 6, 8), and (0, 1, 3) are obtained for the New_group1 and New_group2, New_group1 and New_group4, New_group3 and New_group2, and New_group3 and New_group4, respectively.

In this case, the similar point estimating unit 306 estimates that the two combinations New_group1 and New_group2, and New_group3 and New_group4 of the relative position relationships (0, 2, 2) and (0, 1, 3), which are the same as the indicated point relative position relationship (0, 1, 3) or close to the indicated point relative position relationship (0, 1, 3) correspond to the similar points. In the similar point determination table T10 illustrated in FIG. 24, “o” is written in a similar point box of the combination which is determined to correspond to the similar point and “x” is written in a similar point box of the combination which is determined not to correspond to the similar point. For example, in FIG. 24, two sets of new adjacent groups New_group1 and New_group2, and New_group3 and New_group4 extracted from the new product or the like are extracted as the similar points similar to the indicated point place1, respectively.

A combination (rough combination and the like) having high commonality may be extracted from the similar point estimated from the new product or the like (the product of other model) by the processing unit 30 (e.g., the common classification extracting unit 308). For example, the common classification extracting unit 308 accumulates a false/true determination by a designer or the like for the corresponding similar point and adds a result of the accumulated false/true determinations to the similar point extraction processing by statistical processing to improve preciseness of the extraction of the similar point.

When the processing of operation S33 is terminated, the processing unit 30 performs processing of operation S3 of FIG. 5. The processing of operation S33 may be executed by a back-end system (e.g., the information processing apparatus 1).

During the display of the similar point, the indicated point information about the indicated point similar to the similar point is indicated in the similar point searched in operation S2 and is output on the display screen (e.g., the similar point information display unit 41) of the output unit 40 by the processing unit 30 (similar point reproducing unit 307). For example, the similar point reproducing unit 307 controls a display state of the output unit 40 so that the similar point extracted by the similar point estimating unit 306 for the new product or the like is displayed on the output unit 40. In this case, the similar point information such as, for example, the image of the indicated point and text regarding the reason of the defect, the countermeasure of the defect, or the like, corresponding to the similar point is displayed in the display region of the corresponding similar point of the output unit 40 or a neighboring region (e.g., the indicated point information display unit 41) of the display region.

FIG. 25 is a diagram illustrating an example of a list display screen displaying an indicated point search result. In FIG. 25, the indicated point determined as the point is displayed as a list by the indicated point information display unit 41. The extracted defect similar item, a list of the points, or a defect case of a target (including an indication sentence or an indication image) is displayed. In the defect similar point illustrated in FIG. 25, a cross section is displayed like within an alternated long and short dash line frame.

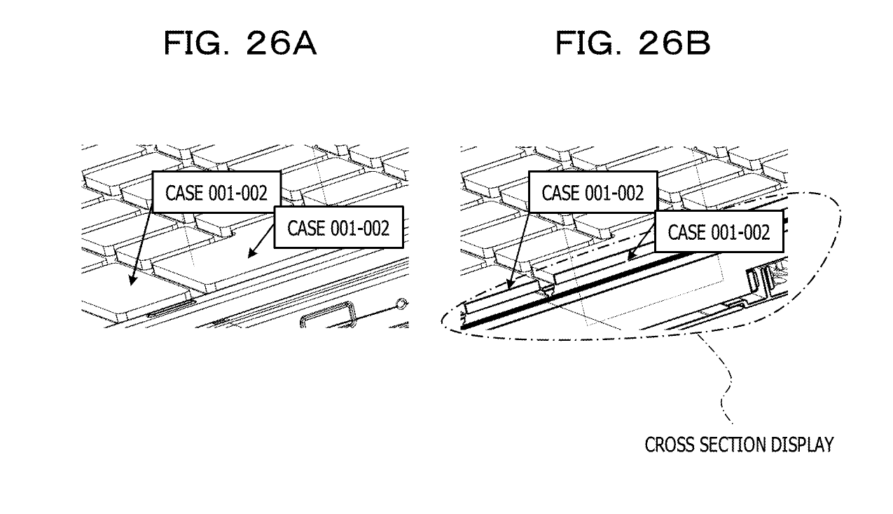

FIGS. 26A and 26B illustrate an example of a similar point display screen. The similar point display screens illustrated in FIGS. 26A and 26B correspond to the display region of the defect similar point illustrated in FIG. 25. In FIG. 26A, a note flag “case001-001” or “case001-002” is given to and displayed in the component to which the indicated point information is given. The note flags “case001-001” and “case001-002” represents that the indicated point information is given. In FIG. 26B, the note flag illustrated in FIG. 26A is given and displayed, and the cross section is displayed as in within the alternated one long and short dash line frame.

The similar point reproducing unit 307 visualizes the defect similar point such as, for example, the similar point similar to the indicated point, on the output unit 40. In this case, as illustrated in FIG. 25, in the display screen of the similar point list, a list display is executed in the unit of an item, such as a defect, a checklist, an individual check. The list display includes the listing of the point extracted as the similar point and registration information of the similar item. In the list display, a cross section of the point may be displayed by a selecting operation of the similar item, in addition to (see, e.g., inside the alternated long and short dash line frames of FIG. 25 and FIG. 26B).

As illustrated in FIG. 26A, the note representing the point may be displayed on the 3D assembly model. In this case, the cross section of the point may be reproduced by selecting the note as illustrated in FIG. 26B. The designer or the like easily confirms a similar condition and confirms a value of a neighboring clearance by performing a list display (not illustrated) confirming the adjacent group point.

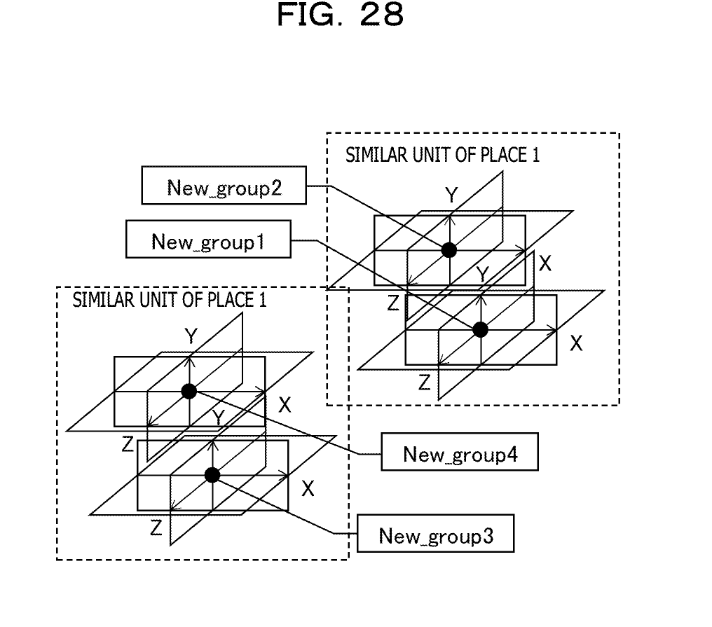

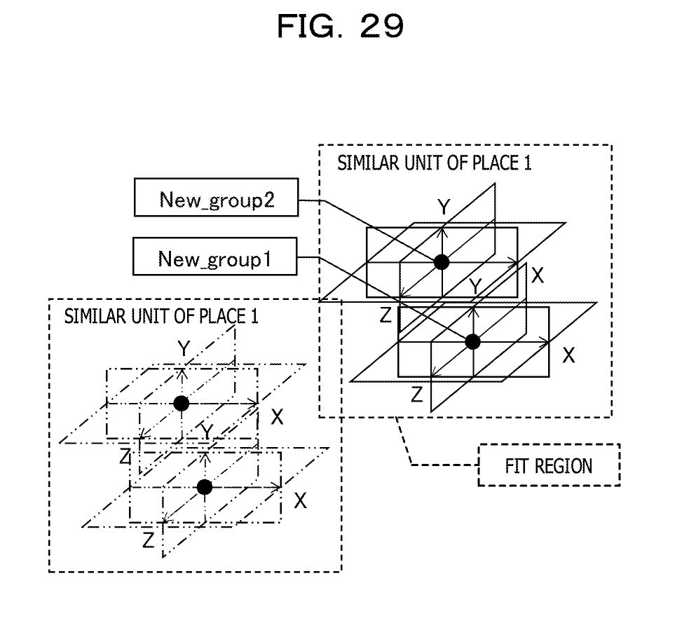

FIG. 27 illustrates an example of a disposition display in a 3D space of a new adjacent group. FIG. 28 illustrates an example of a similar point determination (point-of-attention estimation). FIG. 29 illustrates an example of an operation of the point-of-attention reproducing unit.

When two similar points similar to one indicated point place1 such as, for example, two sets of new adjacent groups New_group1 and New_group2, and New_group3 and New_group4, are extracted and estimated, and the entirety of both two similar points are displayed on the output unit 40 as illustrated in FIGS. 27 and 28, the point-of-attention reproducing unit 310 changes a start position and performs a reproduction display at the indicated point in the similar unit as described below.

In this case, the point-of-attention reproducing unit 310 changes a viewpoint position in which the entirety of the two similar points are positioned within the screen (fit the screen) to a viewpoint position in which only one of the similar points (e.g., the point-of-attention) fits the screen, and as a result, a reproduction display is performed in which only the point-of-attention fits the screen.

For example, the point-of-attention is distinguished for each similarity unit of the indicated point place1 by the similar point (see, e.g., the similar point determination table T10 of FIG. 24) by the point-of-attention reproducing unit 310. For example, it is assumed that a region including all of the new adjacent groups New_group1 to New_group4 in the unit of similarity is currently fitted to a screen size at a viewpoint position in which the adjacent group is visualized on the screen as illustrated in FIG. 28. In this case, as illustrated in FIG. 28, when there are two similar points similar to the indicated point place1, the similar points are distinguished as separate points, respectively. When the new adjacent group New_group1 and New_group2 are selected as the first point-of-attention, a minimum region including all of the regions of the new adjacent groups New_group1 and New_group2 is set to a fit region as illustrated in FIG. 29. A viewpoint position is changed so that the entire screen becomes the fit region and the reproduction display is performed in the output unit 40.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a processor; and
a memory configured to store a program executed by the processor,
wherein the processor, based on the program:
obtains first clearance information about a first clearance between a plurality of first components at an indicated point of a first product;
associates the first clearance information with indicated point information about the indicated point;
obtains second clearance information about a second clearance between a plurality of second components of a second product;
searches for the first clearance information similar to the second clearance information; and
outputs the indicated point information corresponding to the searched first clearance information.

2. The information processing apparatus according to claim 1, wherein the processor:
extracts a plurality of consecutive first facing surface pairs which face each other between the plurality of first components in the indicated point as the first clearance; and
extracts a plurality of consecutive second facing surface pairs which face each other between the plurality of second components in the second product as the second clearance.

3. The information processing apparatus according to claim 2, wherein the processor:
extracts, in the indicated point, a pair of a first component surface and a second component surface which has a minimum first distance from the first component surface, the first distance being equal to or smaller than a first value, from among one or more second component surfaces facing the first component surface as the first facing surface pair; and
extracts, in the second product, a pair of a third component surface and a fourth component surface which has a minimum second distance from the third component surface, the second distance being equal to or smaller than a second value, from among one or more fourth component surfaces facing the third component surface as the second facing surface pair.

4. The information processing apparatus according to claim 1, wherein the first clearance information includes a first classification type of the first component configuring the first clearance and a first cross section according to the first clearance,
the second clearance information includes a second classification type of the second component configuring the second clearance and a second cross section according to the second clearance, when the second classification type matches the first classification type, the processor calculates similarity between the second cross section and the first cross section, and
searches for the first clearance information similar to the second clearance information according to the similarity.

5. The information processing apparatus according to claim 4, wherein the processor:
obtains a cross section including a first geometric center based on a measurement point of the first clearance used when obtaining the first clearance information as the first cross section; and
obtains a cross section including a second geometric center based on a measurement point of the second clearance used when obtaining the second clearance information as the second cross section.

6. The information processing apparatus according to claim 5, wherein the processor:
extracts a similar point of the second product similar to the indicated point of the first product based on a relative position relationship of the first geometric center for the plurality of first components and a relative position relationship of the second geometric center for the plurality of second components.

7. A design support method, comprising:
obtaining, by a computer, first clearance information about a first clearance between a plurality of first components at an indicated point of a first product;
associating the first clearance information with indicated point information about the indicated point;
obtaining second clearance information about a second clearance between a plurality of second components of a second product;
searching for the first clearance information similar to the second clearance information; and
outputting the indicated point information corresponding to the searched first clearance information.

8. The design support method according to claim 7, further comprising:
extracting a plurality of consecutive first facing surface pairs which face each other between the plurality of first components in the indicated point as the first clearance; and
extracting a plurality of consecutive second facing surface pairs which face each other between the plurality of second components in the second product as the second clearance.

9. The design support method according to claim 8, further comprising:
extracting, in the indicated point, a pair of a first component surface and a second component surface which has a minimum first distance from the first component surface, the first distance being equal to or smaller than a first value, from among one or more second component surfaces facing the first component surface as the first facing surface pair; and
extracting, in the second product, a pair of a third component surface and a fourth component surface which has a minimum second distance from the third component surface, the second distance being equal to or smaller than a second value, from among one or more fourth component surfaces facing the third component surface as the second facing surface pair.

10. The design support method according to claim 7, wherein the first clearance information includes a first classification type of the first component configuring the first clearance and a first cross section according to the first clearance,
the second clearance information includes a second classification type of the second component configuring the second clearance and a second cross section according to the second clearance,
when the second classification type matches the first classification type, the processor calculates similarity between the second cross section and the first cross section, a search for the first clearance information similar to the second clearance information is performed according to the similarity.

11. The design support method according to claim 10, further comprising:
obtaining a cross section including a first geometric center based on a measurement point of the first clearance used when obtaining the first clearance information as the first cross section; and
obtaining a cross section including a second geometric center based on a measurement point of the second clearance used when obtaining the second clearance information as the second cross section.

12. The design support method according to claim 11, further comprising:
extracting a similar point of the second product similar to the indicated point of the first product based on a relative position relationship of the first geometric center for the plurality of first components and a relative position relationship of the second geometric center for the plurality of second components.

13. A non-transitory computer-readable recording medium storing design support program which causes a computer to perform operations, the operations comprising:
obtaining, by a computer, first clearance information about a first clearance between a plurality of first components at an indicated point of a first product;
associating the first clearance information with indicated point information about the indicated point;
obtaining second clearance information about a second clearance between a plurality of second components of a second product;
searching for the first clearance information similar to the second clearance information; and
outputting the indicated point information corresponding to the searched first clearance information.

14. The non-transitory computer-readable recording medium according to claim 13, further comprising:
extracting a plurality of consecutive first facing surface pairs which face each other between the plurality of first components in the indicated point as the first clearance; and
extracting a plurality of consecutive second facing surface pairs which face each other between the plurality of second components in the second product as the second clearance.

15. The non-transitory computer-readable recording medium according to claim 14, further comprising:
extracting, in the indicated point, a pair of a first component surface and a second component surface which has a minimum first distance from the first component surface, the first distance being equal to or smaller than a first value, from among one or more second component surfaces facing the first component surface as the first facing surface pair; and
extracting, in the second product, a pair of a third component surface and a fourth component surface which has a minimum second distance from the third component surface, the second distance being equal to or smaller than a second value, from among one or more fourth component surfaces facing the third component surface as the second facing surface pair.

16. The non-transitory computer-readable recording medium according to claim 13, wherein the first clearance information includes a first classification type of the first component configuring the first clearance and a first cross section according to the first clearance,
the second clearance information includes a second classification type of the second component configuring the second clearance and a second cross section according to the second clearance,
when the second classification type matches the first classification type, the processor calculates similarity between the second cross section and the first cross section, a search for the first clearance information similar to the second clearance information is performed according to the similarity.

17. The non-transitory computer-readable recording medium according to claim 16, further comprising:
obtaining a cross section including a first geometric center based on a measurement point of the first clearance used when obtaining the first clearance information as the first cross section; and
obtaining a cross section including a second geometric center based on a measurement point of the second clearance used when obtaining the second clearance information as the second cross section.

18. The non-transitory computer-readable recording medium according to claim 17, further comprising:
extracting a similar point of the second product similar to the indicated point of the first product based on a relative position relationship of the first geometric center for the plurality of first components and a relative position relationship of the second geometric center for the plurality of second components.
